(19) United States
(12) Patent Application Publication
(10) Pub. No.: US 2003/0182214 A1
(43) Pub. Date: Sep. 25, 2003

(54) Fraud detection and security system for financial institutions

(76) Inventor: Michael K. Taylor, Coconut Creek, FL (US)

Correspondence Address: Michael K. Taylor, 2378 NW 34th Road, Coconut Creek, FL, 33066, US

(21) Appl. No.: 10/101,680

(22) Filed: Mar. 20, 2002

(51) Int. Cl. G06F 17/60

(52) U.S. Cl. 705/35

(57) ABSTRACT

A fraud detection and security system for financial institutions utilizes a secure database of information relating to financial transactions of non-account holders who present checks and other instruments for payment. The system collects and tracks the frequency of particular aspects of the subject's behavior, and flags deviations from such norms for the purpose of indicating that fraudulent or criminal behavior may be occurring. At such time, the teller or other employee with whom the subject is dealing may stop the transaction, to the benefit of the financial institution and account holder. The system also allows for law enforcement to detect related transactions, or a string of criminal activity from the same perpetrator. In the preferred mode, the system includes a teller collecting information from the non-account holder, including name, date of birth, address, gender, driver's license number, social security number, and/or telephone number. At the time of the transaction, such data is submitted to the system database and the database returns a response code based upon criteria established by the financial institution's desired security measures, accomplished by installation of new software or by integration of a custom program. The system alerts tellers to suspicious activity, such as when a particular account is accessed more than once in a day, or when the same non-account holder presents items for payment at multiple branches of a banking institution in a short period of time.

### BACKGROUND OF THE INVENTION

1. Field of the Invention:

The present invention is a fraud detection and security system for banking institutions. More particularly, the invention is a system that utilizes a secure database of information relating to financial transactions of non-account holders who present checks and other instruments for payment.

2. Description of the Prior Art:

Numerous innovations for anti-fraud systems have been provided in the prior art and are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

1. U.S. Pat. No. 5,819,226, invented by Gopinathan et al., entitled “Fraud Detection Using Predictive Modeling”

In the patent to Gopinathan, an automated system and method detects fraudulent transactions using a predictive model such as a neural network to evaluate individual customer accounts and identify potentially fraudulent transactions based on learned relationships among known variables. The system may also output reason codes indicating relative contributions of various variables to a particular result. The system periodically monitors its performnance and redevelops the model when performance drops below a predetermined level.

2. U.S. Pat. No. 6,094,643, invented by Anderson, entitled “System For Detecting Counterfeit Financial Card Fraud”

In the Anderson system, counterfeit financial card fraud is detected based on the premise that the fraudulent activity will reflect itself in clustered groups of suspicious transactions. A system for detecting financial card fraud uses a computer database comprising financial card transaction data reported from a plurality of financial institutions. The transactions are scored by assigning weights to individual transactions to identify suspicious transactions. The geographic region where the transactions took place as well as the time of the transactions are recorded. An event building process then identifies cards involved in suspicious transactions in a same geographic region during a common time period to determine clustered groups of suspicious activity suggesting an organized counterfeit card operation which would otherwise be impossible for the individual financial institutions to detect.

3. U.S. Pat. No. 5,884,289, invented by Anderson, entitled “Debit Card Fraud Detection And Control System”

This Anderson patent describes a computer based system that alerts financial institutions (FIs) to undetected multiple debit card fraud conditions in their debit card bases by scanning and analyzing cardholder debit fraud information entered by financial institution (FI) participants. The result of this analysis is the possible identification of cardholders who have been defrauded but have not yet realized it, so they are “at risk” of additional fraudulent transactions. The system also identifies “at risk” cards in the criminal's possession which have not yet been used. The system's early identification of these “at risk” cardholders helps limit losses to individual FIs and the FI community at large. It also provides the coordinated information necessary to the speedy apprehension of the perpetrators.

4. U.S. Pat. No. 6,181,814, invented by Carney, entitled “Check Fraud Detection Techniques Using Encrypted Payee Information”

The Carney patent discloses a system and method for detecting and thus preventing check fraud utilizing a digital computer with image capture and interpretation systems. The system converts the payee information, issue date and the MICR line information (account number, check number and dollar amount) to a check digit which is then placed into the MICR line of a check, printed on its face or transmitted via the paid issuance file to the drawee bank. The drawee bank, upon presentment utilizes a transformation algorithm to convert the printed payee information and issue date on the check into a numerical value that is combined with MICR line information and a check digit is calculated based upon pre-agreed logic. This unique data processing system quickly confirms properly presented checks while effectively precludes payee and other alterations in a cost effective manner.

5. U.S. Pat. No. 5,890,141, invented by Carney, entitled “Check Alteration Detection System And Method”

This Carney patent covers a system and method for detecting and thus preventing check fraud utilizing a digital computer with image capture and interpretation systems. The system converts the payee information, issue date and the MICR line information (account number, check number and dollar amount) to a check digit which is then placed into the MICR line of a check, printed on its face or transmitted via the paid issuance file to the drawee bank. The drawee bank, upon presentment utilizes a transformation algorithm to convert the printed payee information and issue date on the check into a numerical value that is combined with MICR line information and a check digit is calculated based upon pre-agreed logic. This unique data processing system quickly confirms properly presented checks while effectively precludes payee and other alterations in a cost effective manner.

6. U.S. Pat. No. 6,073,121, invented by Ramzy, entitled “Check Fraud Prevention System”

The Ramzy patent discloses a method which improves check fraud prevention systems both in printing and verifying checks at their entry points. The method operates by printing on each issued check, a line of encrypted machine-only readable symbols such as a bar-code that contains all the information printed on the check, using a special, key-selectable encryption algorithm. When a check is presented to a bank teller or a cashier, a required, modified reader/decoder device connected to a computer, will read the line of encrypted data and identify a fraudulent check for rejection. The method requires primarily computer software additions and changes. Expensive replacement of existing equipment is avoided.

7. U.S. Pat. No. 5,896,298, invented by Richter, entitled “System And Method For Providing Central Notification Of Issued Items”

The Richter patent describes a system for, and method of, providing advance notification of issued items. In one embodiment, the system includes: (1) a data collection subsystem that gathers data regarding the issued items from an entity having issued items and transmits the data in a prescribed form and (2) a data storage and communication subsystem, including a central database, that receives the data from the data collection subsystem, combines the data with data gathered from other entities having issued items, stores the combined data in the central database and provides access of the central database to a potential item recipient thereby to allow the potential item recipient to receive advance notification as to whether an item to be received by the potential item recipient was properly issued.

8. U.S. Pat. No. 6,070,141, invented by Houvener, entitled “System And Method Of Assessing The Quality Of An Identification Transaction Using An Identification Quality Score”

In the patent to Houvener, a system and method of assessing the quality of an identification transaction is disclosed. The method includes the following steps: registering a plurality of persons to be identified by providing at least two identification information (ID) units corresponding to each person and storing the ID units in an identification database; assigning an identification quality score to each ID unit; presenting a first ID unit to initiate a transaction where identification is desired; inputting the first ID unit into a point of identification (POI) terminal; establishing a communications link between the POI terminal and the identification database; transmitting the first ID unit to the identification database; searching the identification database and retrieving at least one second ID unit stored in the identification database along with the identification quality score(s) assigned to the retrieved second ID unit(s); transmitting the second ID unit(s) to the POI terminal; displaying the second ID unit(s) and their associated identification quality score(s) on a POI terminal display; comparing the displayed second ID unit with a corresponding second ID unit physically presented by the person being identified; acknowledging a match by entering a command into the POI terminal; storing first, second ID units and transaction information as a transaction record; and adjusting identification quality scores based on historical data.

For the purposes of example, the first above-listed patent to Gopinathan describes a system which uses a “neural network” to evaluate individual customer accounts and identify potentially fraudulent transactions based on learned relationships among known variables. To accomplish the foregoing, the system utilizes a great quantity of data, including account holders' typical frequency of purchases at specific times of the day or week, and in specific geographic areas.

However, the Gopinathan system is primarily designed to prevent credit card fraud, at a juncture prior to the account holder realizing a card has been lost or stolen. Moreover, the Gopinathan system does not function to collect or analyze information relating to particular non-account holders who may be engaging in fraudulent or criminal activity.

The other aforementioned prior art patents illustrate various systems relating to anti-fraud systems, including other systems designed to prevent or detect credit and debit card fraud, systems relating to unauthorized automatic teller machine transactions, and several inventions relating to encryption devices incorporated into checks and instruments themselves.

In contrast to all of the above, the present invention utilizes a database of information relating to transactions of non-account holders who present checks and other instruments for payment. The system collects and tracks the frequency of particular aspects of the subject's behavior, and flags deviations from same to indicate possible fraudulent behavior. In the preferred mode, the system includes a teller collecting information from the non-account holder, including name, date of birth, address, gender, driver's license number, social security number, and/or telephone number. Such data is submitted to the main system database, and the database returns a response code based upon criteria established by the financial institution. Thus, the system alerts tellers to suspicious activity, such as when a particular account is accessed more than once in a day, or when the same non-account holder presents items for payment at multiple branches of a banking institution in a short period of time.

### SUMMARY OF THE INVENTION

As previously noted, the present invention is a fraud detection and security system for banking institutions. More particularly, the invention is a system that utilizes a secure database of information relating to financial transactions of non-account holders who present checks and other instruments for payment.

The system is designed to collect and track the frequency of particular aspects of the subject's behavior, and to flag significant deviations from such norms for the purpose of indicating that fraudulent or criminal behavior may be occurring. At such time, the teller or other employee with whom the subject is dealing may stop the transaction , to the benefit of the financial institution and account holder. Importantly, the system also allows for law enforcement personnel to conveniently detect related transactions, or a string of criminal activity form the same perpetrator.

In the preferred mode of operation, the system includes a teller collecting information from the non-account holder, including name, date of birth, address, gender, driver's license number, social security number, and/or telephone number. At the time of the transaction, such data is submitted to the main system database, and the database returns a response code to the submitting teller based upon criteria established by the financial institution's desired security measures. The above may be accomplished by the installation of new software or by the integration of at least one custom program. As such, the system alerts tellers and the like to suspicious activity, such as when a particular account is accessed more than once in a day, or when the same non-account holder presents items for payment at multiple branches of a banking institution in an unusually short period of time.

Therefore, in total, the system functions to arm all subscribing financial institutions with information necessary to allow their employees to make appropriate decisions when conducting financial transactions.

### BRIEF DESCRIPTION OF PREFERRED EMBODIMENT

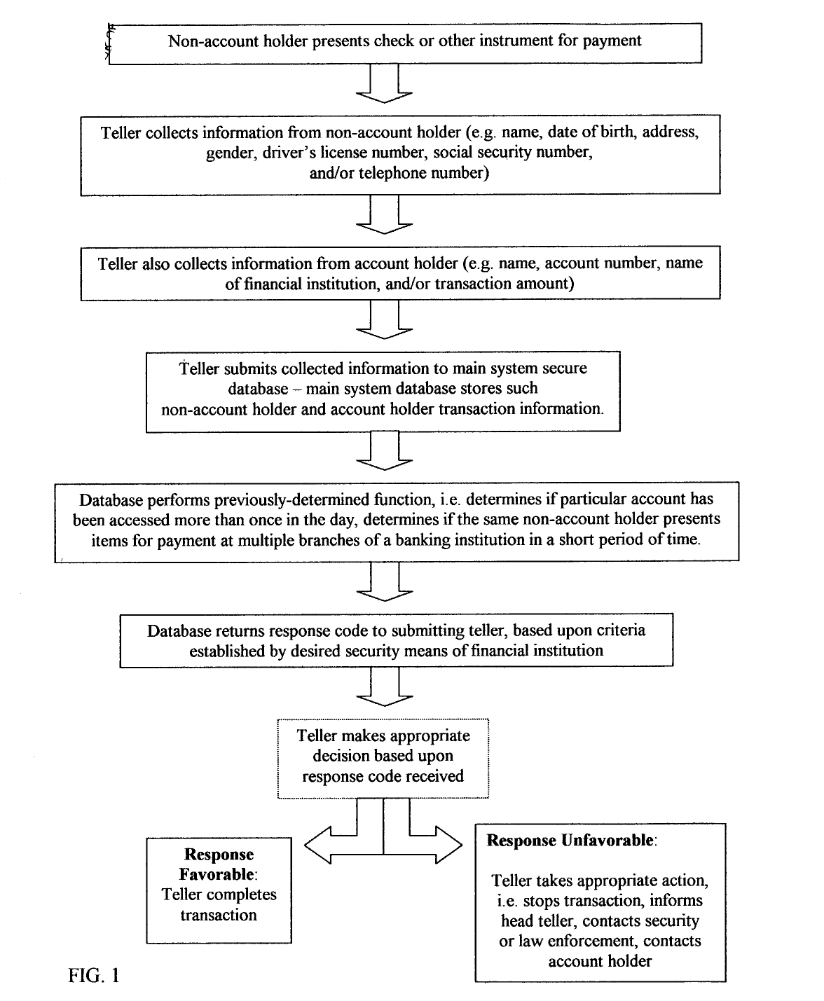

FIG. 1 is a flowchart illustrating the principal stages of utilization of the present system, using a standard transaction for the purposes of example.

### DETAILED DESCRIPTION OF THE PREFERRED EMBODIMENT

To understand both the need for the present system and the unique effectiveness it provides, it is important to first consider the nature of certain fraudulent practices regarding banks and financial institutions. Generally, organized crime rings exist worldwide and participate in a variety of financial-related criminal behavior. In addition to the counterfeiting of written instruments, such organizations participate in stealing legitimate financial instruments, forging or altering them, and cashing them without any method in place to prevent such losses. The fraud rings often utilize fictitious identification for such purposes, and even contract with legitimate persons with legitimate identification to conduct their legitimate transactions for a fee. On a consistent and regular basis, then, the organizations cash stolen and forged written instruments worldwide without protection for the account holders of the financial institutions.

Based on the foregoing, the rationale behind the system of the present invention is relatively simple—it is not normal for an individual to present a check or other written financial instrument to more than one financial institution in the same day, or to multiple branches of the same institution in the same day.

Furthermore, it is not normal for the same account holder's account to be accessed multiple times during the same day, at the same branch or at multiple branches of the same financial institution. The present invention is specifically designed to track these occurrences and alert the institution to the possible fraudulent activity.

As noted in FIG. 1, to accomplish the aforementioned objectives, particular software or a customized computer program is first integrated into bank or other financial institution's previously-existing system for the purposes of carrying out the method of the present invention. Additional hardware may also be integrated into the operation, if deemed necessary to accomplish the states purposes. The operators and administrators of the system may also provide training to the tellers and representatives of banks and financial institutions, to insure that the system is utilized to the height of its efficiency and effectiveness during every transaction.

Commencing the procedure, a non-account holder presents a check or other instrument for payment to a bank or other financial institution. In this context, a non-account holder is defined as a person or business that does not maintain an account at the financial institution at which he or she appears for the transaction. A teller or other representative of the financial institution briefly reviews the item presented, and, importantly, requests additional information from the non-account holder.

The additional information collected from non-account holder includes the person's name, date of birth, address, gender, driver's license number, social security number, and/or telephone number. Such represents a deviation from the ordinary method in which a teller receives an item for payment, which usually incorporates the production of a driver's license or identification card only.

Moreover, information relating to the account holder is collected, including but not limited to that person or company's name, account number, financial institution name, and transaction amount.

The teller or representative then submits this collected information to a main system secure database. This is a fundamental deviation from the ordinary manner in which non-account holders present items for payment, as no such information is tracked using current systems. Such occurs during the attempted transaction, and is intended to take place in a very short period of time, without the knowledge of the non-account holder.

It is important to note, however, that with the acceptance of the present invention and its rise in popularity in the financial industry, non-account holders will likely become aware of the presence of such enhanced anti-fraud measures, which will act as a deterrent to a variety of forms of fraud and criminal activity.

As previously noted, the secure main system database stores, tracks, and archives all such information received from the tellers and representatives of all institutions that participate in the system. Such institutions may be international or global in nature, as the system is suitable for usage in connection with all forms of currency and all languages.

At the stage of the attempted transaction at which the teller transmits the collected information to the database, the database performs a precise, previously-determined function. Such will include an automatic search and evaluation based upon the information submitted.

For the purposes of example only, the function performed by the database may be determining if a particular account has been accessed more than once during the day of the attempted transaction. Similarly, the function may be determining if a particular account has been accessed in excess of a certain number of times within a certain number of days.

Importantly, in this context, the precise formulas and criteria for determining possible fraudulent behavior may be set by the particular bank or financial institution in question. Thus, each bank that is a participant in the system will be given significant latitude in setting the standards and methods by which possible unauthorized activity is evaluated.

Furthermore, also for the purposes of example only, the function performed by the database may be determining if the same non-account holder has presented items for payment at multiple branches of a banking institution in an unusually short period of time. Such is similarly considered a deviation form ordinary banking practices, resulting in a situation that requires greater attention and evaluation.

Regardless of the means by which possible fraudulent activity is measured, the secure main system database returns response code to the submitting teller based upon the criteria established by the financial institution's desired security measures.

The teller or representative is then able to make an appropriate decision based upon the particular response code received from the system. For the purposes of example, this decision may first incorporate stopping the attempted transaction, so that the account holder's funds are not disbursed absent additional investigation or review. Moreover, the teller or representative may inform a head teller or manager of the situation, and may also contact on-site security regarding same.

If warranted from the type of response code received from the system, the teller or representative may also contact the account holder on who's account is being drawn, such as for the purpose of confirming or denying whether the attempted transaction is authorized. Next, if appropriate given the type of response code received from the system, the teller or representative may also contact law enforcement personnel for additional investigation and/or apprehension of the non-account holder.

Finally, regarding law enforcement, it is imperative to note that the system allows for a highly convenient means to detect related fraudulent transactions, as the main system database automatically archives all instances in which the same non-account holder attempts to present items for payment. As such, the system provides a previously-unavailable means to uncover a string of criminal activity from the same perpetrator, regardless of the date, time, or location of such prior fraudulent activities.

In all such instances, the system uniquely functions to arm the teller or representative with the extent of information necessary to make important decisions in a quick and highly convenient manner. The result of such decisions will consistently be protection of the account holder's funds, as well as significant mitigation of the financial institution's losses due to fraud and criminal activity.

With regards to all of the above, while the invention has been described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

1. A fraud detection and security system for financial institutions, the system comprising:
a computer program integrated into a financial institution operating system;
a non-account holder presenting a financial instrument to the financial institution for payment thereof;
a financial institution representative collecting information from the non-account holder regarding identification of the non-account holder, and regarding account holder information;
the financial institution representative submitting the information to a main system secure database during an attempted transaction;
the main system database storing and tracking the information;
the main system database performing a function relating to analysis of the information;
the main system database returning a response code to the financial institution representative, the response code based upon previously-determined criteria established by the financial institution relating to desired security measures
the financial institution representative making an appropriate decision based upon the response code received,
the system functioning to protect account holder funds and mitigate financial institution losses due to fraud and criminal activity.

2. The fraud detection and security system for financial institutions as described in claim 1, wherein the information collected from the non-account holder is selected from the group consisting of the non-account holder's name, date of birth, address, gender, driver's license number, social security number, and telephone number, and account holder's name, account number, financial institution name, and transaction amount.

3. The fraud detection and security system for financial institutions as described in claim 1, wherein the financial institution representative decision, based upon response code received, is selected from the group consisting of stopping a transaction, informing a head teller, contacting security personnel, contacting law enforcement personnel, and contacting the account holder.

4. The fraud detection and security system for financial institutions as described in claim 1, wherein the function performed by the database is selected from the group consisting of determining if a particular account has been accessed more than once in the day, and determining when the same non-account holder has presented items for payment at multiple branches of a banking institution in an unusually short period of time.

5. The fraud detection and security system for financial institutions as described in claim 1, wherein the computer program integrated into the financial institution operating system is a customized program.

6. The fraud detection and security system for financial institutions as described in claim 1, wherein the computer program integrated into the financial institution operating system is a previously-existing software application.

7. A method of operating the fraud detection and security system for financial institutions described in claim 1, the method comprising the steps of:
integrating a computer program into a financial institution operating system;
a non-account holder presenting a financial instrument to the financial institution for payment thereof;
a financial institution representative collecting information from the non-account holder regarding identification of the non-account holder;
the financial institution representative submitting the information to a main system secure database during an attempted transaction;
the main system database storing and tracking the information;
the main system database performing a function relating to analysis of the information;
the main system database returning a response code to the financial institution representative, the response code based upon previously-determined criteria established by the financial institution relating to desired security measures
the financial institution representative making an appropriate decision based upon the response code received;
the system functioning to protect account holder funds and mitigate financial institution losses due to fraud and criminal activity.

8. The method as described in claim 7, wherein the information collected from the non-account holder is selected from the group consisting of the non-account holder's name, date of birth, address, gender, driver's license number, social security number, and/or telephone number.

9. The method as described in claim 7, wherein the financial institution representative decision, based upon response code received, is selected from the group consisting of stopping a transaction, informing a head teller, contacting security personnel, contacting law enforcement personnel, and contacting the account holder.

10. The method as described in claim 7, wherein the function performed by the database is selected from the group consisting of determining if a particular account has been accessed more than once in the day, and determining when the same non-account holder has presented items for payment at multiple branches of a banking institution in an unusually short period of time.

11 The method as described in claim 7, wherein the computer program integrated into the financial institution operating system is a customized program.

12. The method as described in claim 7, wherein the computer program integrated into the financial institution operating system is a previously-existing software application.
